(19) United States
(12) Patent Application Publication
(10) Pub. No.: US 2011/0174804 A1
(43) Pub. Date: Jul. 21, 2011

(54) Method and Melt Channels for Interrupting and Restoring the Melt Stream of Iron and Metal Melts in Tap Hole Channels of Blast Furnaces and Drainage Channels of Melt Furnaces

(76) Inventors: Klaus Spies, Aachen-Schmithof (DE); Philippe Mallvoir, Errouville (FR); Laude Meisch, Roeser (LU); Luc Richartz, Diekirch (LU); Peter Cramer, Burbach (DE); Han-Uwe Morgenstem, Freudenburg (DE); Jürgen Pithan, Siegen (DE); Ralf Taugerbeck, Netphen (DE)

(21) Appl. No.: 13/057,909

(22) PCT Filed: Aug. 6, 2009
(86) PCT No.: PCT/EP2009/060221

§ 371 Date: Mar. 30, 2011

(30) Foreign Application Priority Data
Aug. 7, 2008 (DE) 10 2008 036 791.5

(51) Int. Cl. H05B 6/10; C21B 7/12

(52) U.S. Cl. 219/602; 266/45; 266/236

(57) ABSTRACT

The invention relates to a method for interrupting and restoring the melt stream of iron and metal melts in melt channels, in particular tap hole channels, of blast furnaces and drainage channels of melt furnaces. The method is characterized by a transition of the melt stream in the melt channels to the solidified state through cooling so that the melt stream can be interrupted, and by a melting of the solidified melt and a restoration of the melt stream through heating, in particular for re-establishing tapping of blast furnaces.

The invention relates to a Method and melt channels for interrupting and restoring the melt stream of iron and metal melts in tap hole channels of blast furnaces and drainage channels for melt furnaces.

In most cases, melts flow out of metallurgical containers such as blast furnaces and melt furnaces, and also similar installations for specified periods. After such periods, the melt stream is interrupted and is restored again later. A variety of devices exist for interrupting melt streams, such as sliders and flap valves. The plugging method, in which a plastic mass specially developed for this purpose is pressed into the tap hole channel under high pressure, is used for the tap holes in almost all blast furnaces. The plug mass hardens in the tap hole channel and must be drilled through in order to begin the next tapping operation. This requires the use of expensive technical equipment.

German patent Die DE 34 43 143 Al describes a method for alternately opening and closing a tap hole in furnaces, in which the tap hole channel is first blocked with a shut-off device. Then, a plugging gun is placed in the opening of the tap hole channel and the tap hole channel is completely filled with plugging mass from the plugging gun as soon as the shut-off device is opened again. After the tap hole channel has been filled, but before the plugging mass has hardened completely, a tapping rod is driven through the middle of the plugging mass and into the furnace with the aid of a drill, and the tapping rod is withdrawn from the tap hole channel again on the occasion of the next tapping procedure.

Most recently, there have also been suggestions to press age-hardening powder into the tap hole channel of a blast furnace from cartridges to create a closure of the channel until the next tapping operation.

The object underlying the invention is to develop a method and melt channels, particularly tap hole channels for blast furnaces and drain channels for melt furnaces, which eliminate the disadvantages of the known methods, particularly of the tap hole plugging method for blast furnaces, and the associated equipment for interrupting and restoring a melt stream in a melt channel.

This object is solved according to the invention with a method having the features of claim 1 and the melt channel for iron and metal melts having the features of claim 7.

The subordinate claims describe advantageous and practical refinements of the method according to claim 1 and the melt channel according to claim 7.

The method according to the invention for interrupting and restoring the melt stream of iron and metal melts in channels, particularly tap hole channels in blast furnaces and drain channels in melt furnaces, is characterized by transition of the melt stream in the channels to the solidified state by cooling so as to interrupt the melt stream, and the solidified melt is remelted by heating to restore the melt stream, particularly for a subsequent tapping operation in blast furnaces.

When the melt that has been solidified in the tap hole channel of a blast furnace or in the drain channel of a melt furnace to form a plug is heated in the peripheral area thereof, the entire plug is forced out of the tap hole channel or the drain channel, together with the solidified plug core, by the internal pressure of the blast furnace or melt furnace.

To accelerate the solidification process, and thereby also reduce energy consumption, it is possible to block the outflow opening of the tap hole channel or drain channel before the melt stream solidifies.

A further possibility for speeding up the solidification process of the melt consists in passing the melt steam through at least one magnetic field with constant polarity or at least one alternating magnetic field before it solidifies in the flow channel, particularly the tap hole channel, in such manner that a voltage is induced in the melt stream, which in turn creates eddy currents in the melt stream, and the interaction of the magnetic field and the eddy currents generates forces in the opposite direction to the direction of flow of the melt stream, which serve to slow the flow velocity of the melt stream or to stop the flow stream entirely.

If the melt stream undergoes controlled cooling, particularly in the tap hole channel of a blast furnace or the drain channel of a melt furnace, a solidified layer of melt may be formed in the outer flow region on the interior wall of the channels to protect it against abrasion by the melt stream that continues to flow in the central region. In this context, the flow rate in the outer region of the melt stream may be slowed by corresponding conformation of the interior wall of the tap hole channel or drain channel so that the solidification process is accelerated.

In the following, various embodiments of a tap hole channel for interrupting the melt stream when a tapping operation is completed in a blast furnace and for restoring the melt stream for a subsequent tapping operation will be explained with reference to diagrammatic drawing figures, in which:

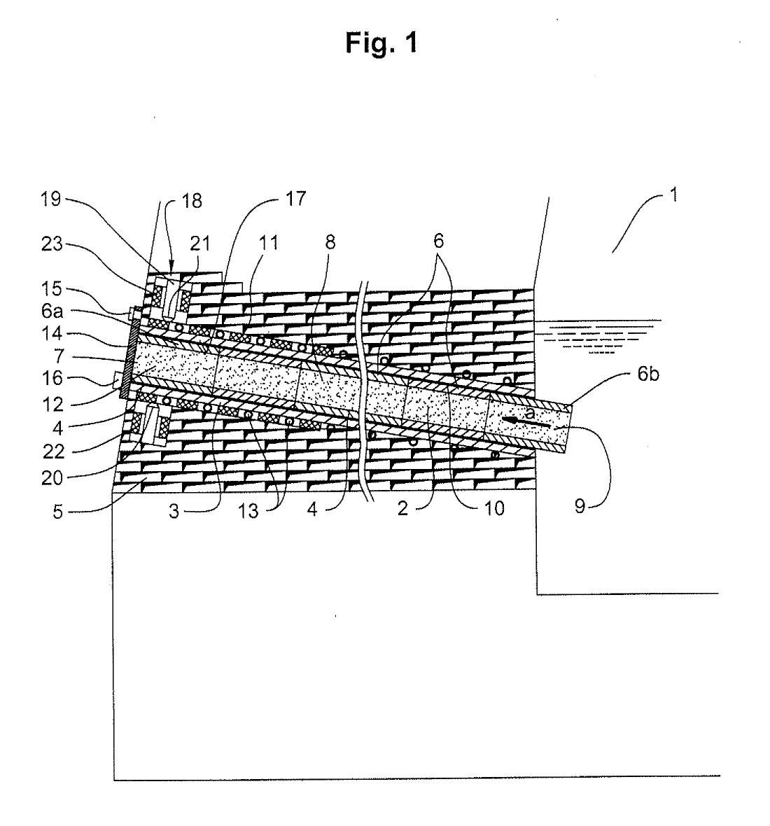

FIG. 1 shows a longitudinal cross section through a tap hole channel of a blast furnace formed by an outer pipe and an inner pipe and having a cooling device and a heating device for adjusting and slowing the flow velocity of the melt stream flowing through the tap hole channel;

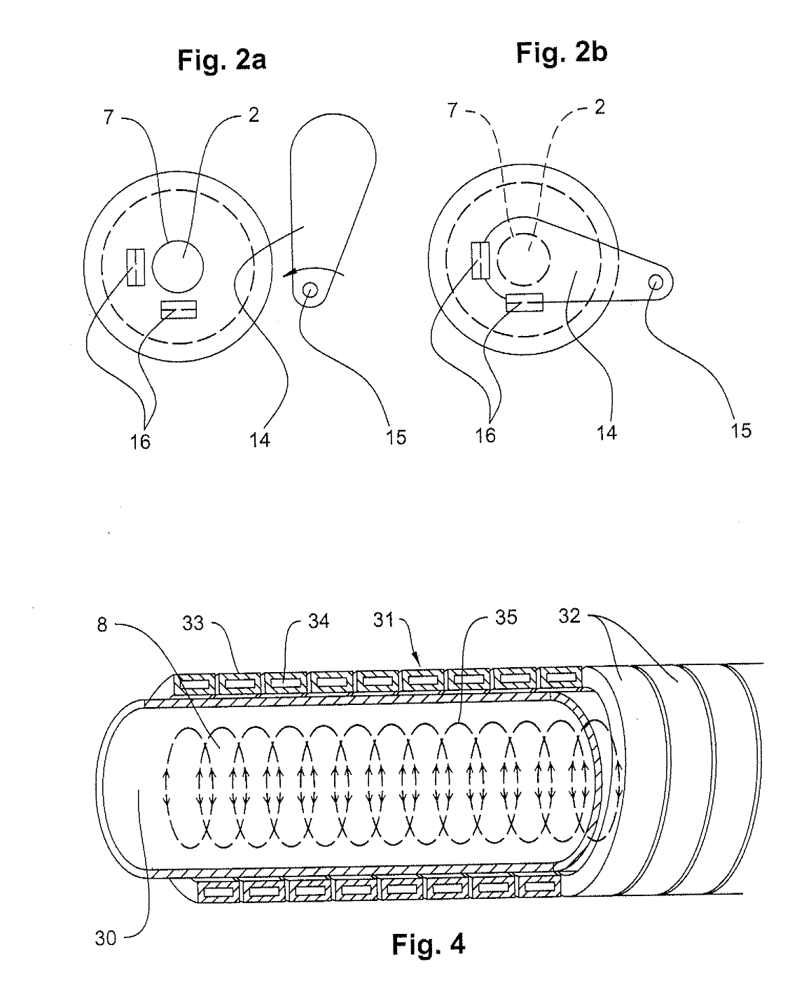

FIGS. 2a and 2b show a pivoting flap for blocking the outflow opening of the tap hole channel in the open and closed positions,

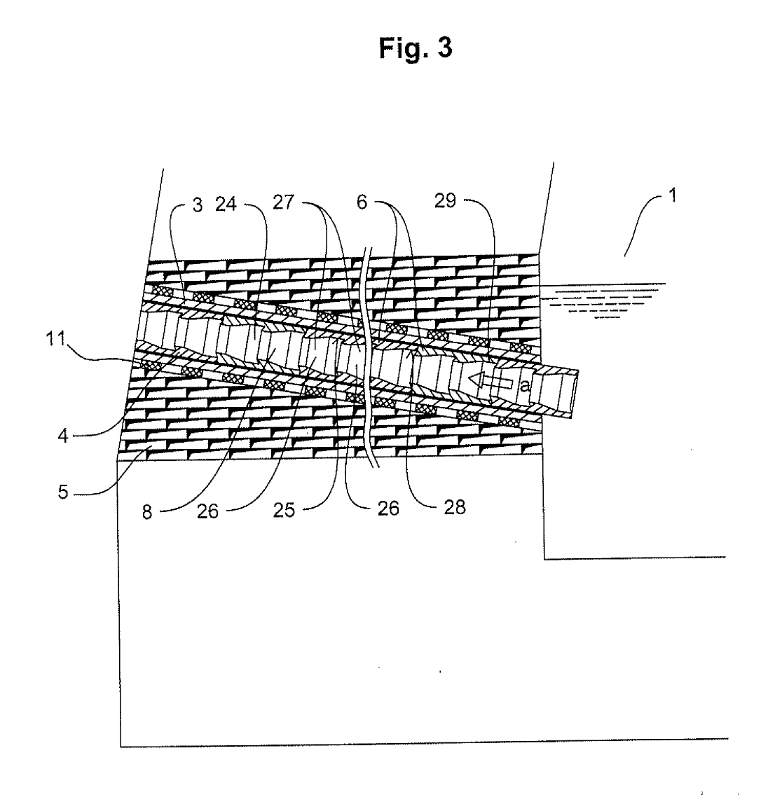

FIG. 3 shows a longitudinal cross section through a further embodiment of the tap hole channel having an outer pipe and an inner pipe with a contoured inner wall; and

FIG. 4 shows a partial longitudinal cross section of a third embodiment of a tap hole channel having a cooling coil that is combined with an electric heating coil.

The tap hole channel 2 of a blast furnace 1 shown in FIG. 1 is formed by an outer pipe 3 and an inner pipe 4 that is axially displaceable therein, wherein outer pipe 3 is immovably connected to refractory lining 5 of blast furnace 1. Both pipes 3, 4 are made from an extremely resistant, preferably ceramic material, and the material of inner pipe 4, which serves to protect against abrasion wear from the outflowing raw iron and slag, is also resistant to abrasion.

Inner pipe 4 consists of pipe sections 6, which are replaced at certain time intervals by new pipe sections 6a to compensate for the effects of abrasion wear, the new inner pipe sections 6a being pushed against flow direction a of melt stream 8, through outflow opening 7 of tap hole channel 2 and into outer pipe 3, so that at the same time worn pipe sections 6b are pushed out of outer pipe 3, through inflow opening 9 of tap hole channel 2 and into the blast furnace 1. Inner pipe section 6b, through which melt stream 8 enters tap hole channel 2 of blast furnace 1, extends a certain length into blast furnace 1 to protect outer pipe 3 and refractory lining 5 of blast furnace 1 from abrasion wear. This inner pipe section 6b fulfils the function of the “mantle” on the inside of the refractory lining of a blast furnace in the conventional tapping method. The time interval at which new pipe sections 6a are pushed in is selected so as to avoid destroying inner pipe sections 6, and thereby prevent all contact between the slag and outer pipe 3. A mineral-based lubricant 10, which reaches its full lubricating capability at the high temperatures of the outflowing iron and slag, is present between outer pipe 3 and inner pipe sections 6 and prevents the melt from getting into the gap between inner pipe sections 6, which would then solidify and fuse inner pipe sections 6 with outer pipe 3.

Tap hole channel 2 is equipped with a cooling device in the form of tubular cooling coils 11 that surround outer pipe 3 in the channel section adjacent to outflow opening 7 of tap hole channel 2, since a sufficiently solid sealing plug 12 is formed in the outflow area of tap hole channel 2 after a tapping operation on blast furnace 1 by solidification of the melt that is brought about by the coolant flowing through cooling coils 11.

A heating device in the form of an electric heating coil 13 surrounding tap hole channel 13 serves to remelt solidified sealing plug 12 in the section of tap hole channel 2 adjacent to outflow opening 7 in preparation for another tapping operation.

Depending on the length of the idle time between two tapping operations, the melt in the rear section of the tap hole channel on the furnace side will either solidify and/or remain flowable because the times between two tapping operations—particularly if irregularities occur in the operating workflows—may be variable. Therefore, the heating devices for remelting the solidified melt material must be capable of heating effectively along the entire length of the tap hole channel.

Moreover, energy-saving electric induction coils arranged around tap hole channel 2 may be used as the heating device, and to heat and remelt the melt by generating eddy currents in the solidified melt with magnetic fields. The winding of the induction coils is conformed as a hollow profile that forms a flowthrough channel for a coolant to prevent the coil winding from being damaged due to overheating by the electric current passed through it and the exhaust heat from the blast furnace.

A blocking element in the form of a flap valve 14 or slider is arranged in front of outflow opening 7 of tap hole channel 2 to close the outflow opening of the channel before the melt is solidified in the cooling operation. The flap valve 14 shown in FIGS. 2a and 2b is pivotable about an axis 15 and is retained in the pivoted, closing position in front of tap hole channel 2 by two limit stops 16. Limit stops 16 ensure that flap valve 14 is able to absorb the forces resulting from the internal pressure of the blast furnace. The forces exerted on the flap valve diminish as the melt solidifies in the tap hole channel of the blast furnace.

The side of flap valve 14 facing towards tap hole channel 2 is coated with a thick layer of fireproof material with the result that the valve sustains no damage of any kind due to contact with the extremely hot melt even after long periods of operation.

When melt stream 8 has been interrupted by the closing of flap valve 14, cooling of the melt in tap hole channel 2 may be carried out with little cooling effort and consequently with less energy consumption.

The induction coils for remelting the solidified melt plug 12 in tap hole channel 2 by eddy currents for a subsequent tapping operation are designed in such manner that remelting occurs in surface area 17 of the plug adjacent to the inner wall of inner pipe 4, the diameter of melt plug 12 is reduced thereby and the plug is forced out of tap hole channel 2 by the internal pressure of blast furnace 1 when flap valve 14 is opened, and the remelted melt material serves as a lubricant.

The possibility exists to implement a contactless method for slowing the melt stream with magnetic fields instead of using flap valve 14 or in addition to the flap valve.

According to FIG. 1, a device 18 is arranged in the channel section adjacent to outflow opening 7 of tap hole channel 2 to adjust the flow velocity and slow the non-ferromagnetic melt stream 8 having a core 19 of ferromagnetic material, the device being equipped with two poles 20, 21 that are located on opposite sides of tap hole channel 2 of blast furnace 1, and with induction coils 22, 23 located on core 19 to generate a magnetic field which induces a voltage in the melt stream 8, thus in turn creating eddy currents in the melt stream, which eddy currents interact with the magnetic field to generate forces that act in the opposite direction to flow direction a of melt stream 8 and via which the melt stream may be slowed and even stopped completely.

The tap hole channel 24 shown in FIG. 3 is formed by an outer pipe 3 and an inner pipe 4 that consists of pipe sections 6, the inner walls 25 of which are constructed in the manner of platforms 26 in such manner that a serial arrangement of platforms is created, the openings 27 of which become smaller in flow direction a of melt stream 8. The serial arrangement of platforms 26 has the effect of significantly slowing the flow velocity of melt stream 8 at the inner walls 25 of inner pipe sections 6 relative to the flow velocity of the central melt stream. Due to the low flow velocity of melt stream 8 in the area close to the inner wall of pipe sections 6 of inner pipe 4 of tap hole channel 2, it is possible for the coolant flowing through the cooling coil 3 surrounding outer pipe 3 of tap hole channel 2 to cool the melt very effectively in this area while the quickly flowing melt stream in the middle is cooled only slightly if at all. By controlling the cooling process precisely, a solidified melt layer 29 providing protection against wear forms on inner wall 28 of inner pipe 4 that is formed by inner walls 25 of inner pipe sections 6. This provides a significant benefit for operating the blast furnace or melt furnace and for carrying out maintenance on the technical elements of the furnace.

The tap hole channel 30 shown in part in FIG. 4 is equipped with a combined cooling and heating coil 31, winding 32 of which is constructed as a hollow profile 33 from an electrically conducting material, particularly copper, wherein a coolant that flows through flowthrough channel 34 formed by hollow profile 33 causes a melt stream 8 to solidify in tap hole channel 30 of a blast furnace 1 or a drain channel of a melt furnace, and wherein the cooling and heating coil 31, which is connected to a high-frequency alternating current with high current densities generates large eddy currents 35 in the solidified melt in tap hole channel 30 to remelt the melt with a throttled coolant flow to avoid overheating coil winding 32 in order to initiate a repeated tap hole operation.

Due to the skin effect, the eddy currents generated become stronger and stronger with increasing frequency in the solidified outer layer close to the inner wall of the tap hole channel and cause local heating. If the applied current density is sufficiently high in the coil, the eddy currents will also have correspondingly high current densities, with the result that they contain enough energy to liquefy the outer layer of melt. In this state, the flow rate of coolant through the coil winding is dimensioned such that undesirable cooling of the melt does not occur, while at the same time preventing the winding from becoming overheated due to the very high current densities. The skin effect will also operate in the winding in such manner that the electrical current will essentially flow in the outer layers of the coil material at high frequencies, so that the coolant in the flow channel of the coil will not negatively affect the eddy current generating function of the induction coil.

It is possible to create the combined cooling and heating coil system 31 from a plurality of coil sections arranged side by side. In this way, it is possible to achieve better adaptation to the varying conditions and requirements along the length of tap hole channel 30. This also improves the cooling effect and lowers the inductance of the partial sections of the coil, so that it may be operated at a higher frequency to obtain the advantages described above.

For the purpose of optimum effectiveness, the combined cooling and heating coil is integrated in an LC resonant circuit that is operated by a corresponding controller and driven at the resonance point.

1. A method for interrupting and restoring a melt stream of iron and metal melts in a melt channel, such as a tap hole channel of a blast furnaces or a drainage channels of a melt furnace, said method comprising:
transitioning a melt stream in a melt channel to a solidified state forming a solidified melt by cooling to interrupt the melt stream after a tapping operation in a furnaces; and
remelting the solidified melt and restoring the melt stream by heating in preparation for a subsequent tapping operation in the furnaces.

2. The method as recited in claim 1, in which remelting the solidified melt includes heating the peripheral area of the solidified melt in such manner that the solidified melt is forced out of the melt channel by the internal pressure in the furnace.

3. The method as recited in claim 1, in which an outflow opening of the melt channel is closed off before the melt stream is solidified therein.

4. The method as recited in claim 1, in which before the melt stream is solidified in the melt channel, the melt stream is passed in a known manner through at least one magnetic field with constant polarity or through at least one alternating magnetic field in such manner that a voltage is induced in the melt stream, via which eddy currents are created in the melt stream, and that the magnetic field and the eddy currents interact to generate forces in the opposite direction to the direction of flow of the melt stream, which slow the flow velocity of the melt stream or completely stop the melt stream.

5. A method for controlling a melt stream of iron and metal melts in a melt channel, such as a tap hole channels of a blast furnaces or drainage channel of a melt furnace, said method comprising:
controlling cooling of the melt stream in an outer flow region of the melt stream to form a solidified melt layer on an inner wall of the melt channel to protect the from abrasion.

6. The method as recited in claim 5, in which a flow velocity in the outer flow region of the melt stream is slowed by corresponding conformation of the inner wall of the melt channel in order to accelerate the process of solidifying the melt.

7. A melt channel of a furnace for iron and metal melts having devices for interrupting and restoring a melt stream, said melt channel comprising:
at least one channel section
a cooling device surrounding the channel section for transitioning the melt stream into a solidified state forming a solidified melt; and
a heating device for remelting the solidified melt and restoring the melt stream.

8. The melt channel as recited in claim 7, in which the channel section is adjacent to an outflow opening of the melt channel.

9. The melt channel as recited in claim 7, in which the heating device is positioned along the entire length or over a of the melt channel.

10. The melt channel as recited in claim 7, in which the cooling device is one or more tubular cooling coils through which a coolant can flow.

11. The melt channel as recited in claim 7, in which one or more electric heating coils (13) positioned around the melt channel to remelt the solidified melt.

12. The melt channel as recited in claim 7, in which the heating device includes at least one electrical induction coil surrounding the channel section to generate eddy currents via magnetic fields which heat and remelt the solidified melt.

13. The melt channel as recited in claim 7, in which said heating device and said cooling device are at least one combined cooling and heating hollow electrically conductive coil having a flowthrough channel, wherein a coolant that flows through the flowthrough channel causes the melt stream to solidify forming a solidified melt in the channel section, and wherein the cooling and heating coil, which is connected to a high-frequency alternating current with high current densities, generates large eddy currents in the solidified melt in channel section to remelt the solidified melt with a throttled coolant flow to avoid overheating of the coil in order to initiate a repeated tap hole operation in the furnace.

14. The melt channel as recited in claim 7, in which the melt channel includes an outflow region and a flow control device arranged in the outflow region to adjust the flow velocity and slow an electrically conductive melt stream having ferromagnetic material, the flow control device having two poles (20, 21) that are located on opposite sides of a channel section, and with induction coils located adjacent the melt stream to generate a magnetic field which induces a voltage in the melt stream, thereby creating eddy currents in the melt stream, which eddy currents interact with the magnetic field to generate forces that act in the opposite direction to a flow direction of the melt stream and via which the melt stream may be slowed and even stopped completely.

15. The melt channel as recited in claim 11, in which the electric heating coils are constructed as a hollow profile forming a flowthrough channel for a coolant to prevent the coil winding from being damaged due to overheating by the electric current passed through coils and the exhaust heat from the furnace.

16. The melt channel as recited in claim 7, in which a blocking element selectively closing off an outflow opening of the melt channel before the melt is solidified in the channel.

17. The melt channel as recited in claim 7, in which the channel section is formed by an outer pipe and an inner pipe that is axially displaceable therein, wherein the outer pipe is immovably attached to a refractory lining of the furnace, wherein the inner and outer pipes are made from ceramic material.

18. The melt channel as recited in claim 17, in which the inner pipe consists of inner pipe sections that are replaced with new pipe sections at certain time intervals to compensate for the abrasion wear, wherein the new pipe sections are pushed against a flow direction of the melt stream, through an outflow opening of the melt channel into the outer pipe, so that at the same time worn pipe sections are pushed out of the outer pipe, through an inflow opening of the melt channel, and into the furnace.

19. The melt channel as recited in claim 18, in which the inner pipe sections have openings which become smaller in the flow direction of the melt stream to slow the flow velocity of the melt stream in an outer region of the flow stream so as to create a solidified melt layer on an inner wall of the melt channel for protecting against wear by intensive cooling of the melt with the aid of the coolant that flows through the cooling coil or coils that surround the outer pipe of the melt channel.
